(19) United States
(12) Patent Application Publication
(10) Pub. No.: US 2009/0040603 A1
(43) Pub. Date: Feb. 12, 2009

(54) Objective lens

(75) Inventors: Tatsuya Nagahama, Kawasaki-shi (JP); Katsuyoshi Arisawa, Tokyo (JP)

Correspondence Address: OLIFF & BERRIDGE, PLC, P.O. BOX 320850, ALEXANDRIA, VA, 22320-4850, US

(73) Assignee: MITUTOYO CORPORATION, Kawasaki (JP)

(21) Appl. No.: 12/222,364

(22) Filed: Aug. 7, 2008

(30) Foreign Application Priority Data
Aug. 9, 2007 (JP) 2007-207667

(51) Int. Cl. G02B 21/04; G02B 27/10; G02B 21/06

(52) U.S. Cl. 359/389; 359/629

(57) ABSTRACT

In order to provide an objective lens which can reduce the generation of flare light, an objective lens including a front-group lens, a rear-group lens arranged on an optic axis of the front-group lens with the front-group lens interposed between an object plane and the rear-group lens, and a semitransparent mirror arranged between the front-group lens and the rear-group lens for reflecting illumination into the front-group lens, transmitting reflected light from the object plane and entering the transmitted light into the rear-group lens is provided. The front-group lens is a single lens or a cemented lens formed by sticking two lenses together.

### BACKGROUND

Embodiments described herein relate to objective lenses.

There has heretofore been known a microscope apparatus which includes an objective lens, and in which an electronic picture is obtained by imaging means, while an ocular observation can be performed by an ocular lens (refer to, for example, Japanese Patent Document No. JP-A-2006-317761).

FIG. 12 is a schematic diagram of the optical system 110 of an microscope apparatus including the prior-art objective lens 101 as disclosed in Japanese Patent Document No. JP-A-2006-317761. Referring to FIG. 12, numeral 105 designates a light source, numeral 111 designates a beam splitter, numeral 101 designates the objective lens, and numeral 104 designates an imaging lens. Illumination light from the light source 105 is reflected by the beam splitter 111 and the reflected light is projected onto an object plane 102 through the objective lens 101. Light reflected by the object plane 102 is transmitted through the beam splitter 111 and the transmitted light is condensed by the imaging lens 104 so as to be imaged on an image plane 103.

In the microscope apparatus disclosed in Japanese Patent Document No. JP-A-2006-317761, however, the objective lens 101 is configured of a plurality of lenses, as shown in FIG. 13, in order to correct various aberrations caused by the imaging. Hence, flare light generated by the surfaces of the respective lenses of the objective lens 101 has been a problem. Flare light is light in which a mist seems to hang and which develops in such a way that the light for illumination causes reflections and scatterings at the surfaces of the objective lens and in the interior thereof. That is, illumination light 106 that has entered from the light source 105 into the beam splitter 111 is reflected by the beam splitter 111 and is projected into the objective lens 101, so that it causes a reflection at the lens surface of the objective lens 101 and generates flare light 107.

In a case where the objective lens 101 is configured by combining the plurality of lenses L101-L105 as shown in FIG. 13, flare light 107 increases in correspondence with the number of the lenses, and hence, the light quantity of flare light 107 sometimes becomes large enough to hinder a measurement. When the light quantity of flare light 107 is large, the contrast decreases leading to a worsening in appearance causing the appearance to sometimes become problematic in practical use in spite of favorable corrections of the aberrations.

### SUMMARY

An object, but not a requirement, of one or more embodiments described herein is to provide an objective lens which can reduce the development of flare light.

The objective lens is characterized by a front-group lens; a rear-group lens arranged on an optic axis of the front-group lens with the front-group lens interposed between an object plane and the rear-group lens; and a semitransparent mirror arranged between the front-group lens and the rear-group lens, the semitransparent mirror for reflecting illumination light into the front-group lens, transmitting reflected light from the object plane and entering the transmitted light into the rear-group lens; wherein the front-group lens is a single lens or a cemented lens formed by sticking two lenses together.

According to embodiments, the semitransparent mirror is arranged between the front-group lens and the rear-group lens so that the illumination light reflected by the semitransparent mirror is projected onto the object plane through the front-group lens while the reflected light reflected by the object plane is transmitted through the semitransparent mirror and is projected onto an image plane side through the rear-group lens. Flare light is generated when the illumination light being projected onto the object plane through the objective lens is reflected by the lens surfaces of the objective lens. Therefore, when the semiconductor mirror is arranged between the front-group lens and the rear-group lens, flare light may only be generated by the lens surfaces of the front-group lens and may not be generated from the lens surfaces of the rear-group lens. Further, since the front-group lens is made of a single lens or a cemented lens formed by sticking the two lenses together, the number of lens surfaces generating flare light may be smaller than in the prior-art objective lens and the quantity of flare light can be reduced.

In the objective lens, the rear-group lens should preferably be made of a plurality of lenses. Flare light is not generated from the lenses constituting the rear-group lens, which may lead to comparatively high design versatility. Accordingly, when the rear-group lens is configured to include a plurality of lenses, various aberrations can be corrected and lens performance can be enhanced.

In the objective lens, light which passes between the front-group lens and the rear-group lens may be in a state where it is parallel to the optic axis. Therefore, the arrangement of the optical system between the front-group lens and the rear-group lens can provide versatility, which can allow the semitransparent mirror to be arranged between the front-group lens and the rear-group lens.

The objective lens may comprise a holding cylinder, which is a cylinder member of substantially circular cylindrical shape in which the front-group lens, the semitransparent mirror and the rear-group lens are assembled and held; and the holding cylinder is formed with a hole which penetrates into the interior of the holding cylinder where the hole may be in a substantially central part of an outer wall surface of the holding cylinder; wherein light illuminates the object plane by entering into the semitransparent mirror through the hole.

In embodiments, the front-group lens, the transparent mirror and the rear-group lens are assembled and held in the holding cylinder, and hence, they can be easily attached to and detached from, for example, a microscope or like optical equipment, as well as a projector, a picture processing measurement equipment or the like.

### BRIEF DESCRIPTION OF THE DRAWINGS

Various exemplary details of systems and methods are described, with reference to the following figures, wherein:

FIG. 1 is a conceptual diagram showing an optical system, which includes an objective lens according to at least one embodiment.

FIG. 2 is a diagram showing a microscope in which the objective lens is mounted.

FIG. 3 is a diagram showing the configuration and optical paths of an objective lens in a first embodiment.

FIG. 4 is a diagram showing the various aberrations of the objective lens of the first embodiment.

FIG. 5 is a diagram showing the configuration and optical paths of an objective lens in a second embodiment.

FIG. 6 is a diagram showing the various aberrations of the objective lens of the second embodiment.

FIG. 7 is a diagram showing the configuration and optical paths of an objective lens in a third embodiment.

FIG. 8 is a diagram showing the various aberrations of the objective lens of the third embodiment.

FIG. 9 is a diagram showing the configuration and optical paths of an objective lens in a fourth embodiment.

FIG. 10 is a diagram showing the various aberrations of the objective lens of the fourth embodiment.

FIG. 11 is a diagram showing the configuration and optical paths of an objective lens according to a modified embodiment.

FIG. 12 is a conceptual diagram showing an optical system which includes a prior-art objective lens.

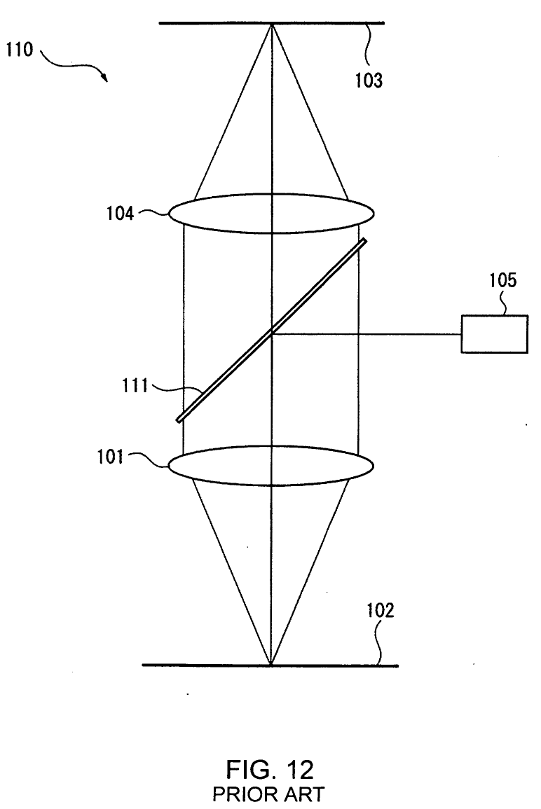

FIG. 13 is a diagram illustrating a problem in the prior-art objective lens.

These and other features and details are described in, or are apparent from, the following detailed description.

### DETAILED DESCRIPTION OF EMBODIMENTS

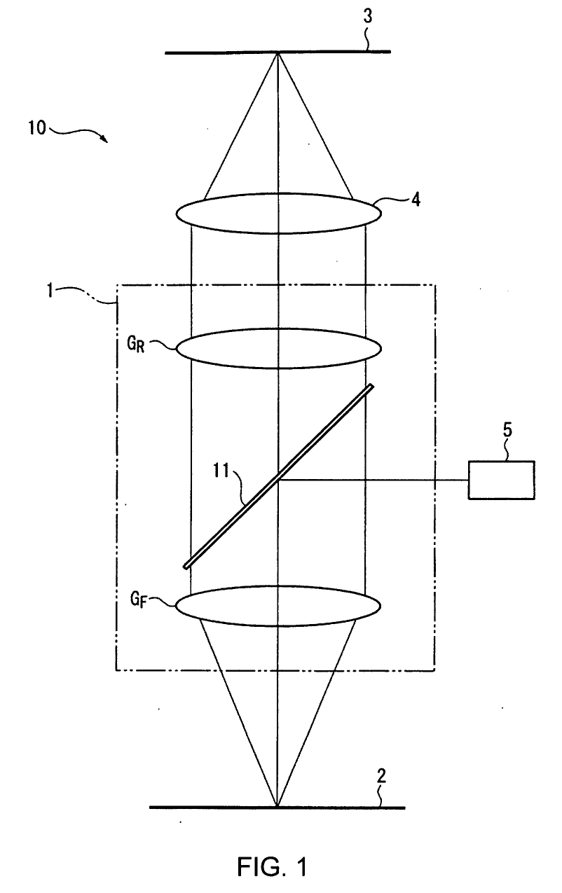

Now, aspects of embodiments will be described in conjunction with the drawings. FIG. 1 is a conceptual diagram showing an optical system 10, which includes an objective lens 1. In the optical system 10, between an object plane 2 and an image plane 3, the objective lens 1 and an imaging lens 4 are arranged on an identical optic axis in order nearer to the object plane 2. The objective lens 1 includes a front-group lens G_{F} on the side of the object plane 2, a rear-group lens G_{R} on the side of the image plane 3, and a semitransparent mirror 11 arranged between the front-group lens G_{F} and the rear-group lens G_{R}. In addition, the optical system 10 with the objective lens 1 includes an illumination device 5, which provides illumination light to the semitransparent mirror 11 of the objective lens 1.

When the illumination light from the illumination device 5 enters into the semitransparent mirror 11 parallel to the object plane 2, it is reflected by the semitransparent mirror 11 and is projected in a direction orthogonal to the object plane 2. Light reflected by the object plane 2 is turned into a parallel beam by the objective lens and enters into the imaging lens 4. Light passed through the imaging lens 4 is imaged on the image plane 3. In this manner, epi-illumination is formed in the optical system 10.

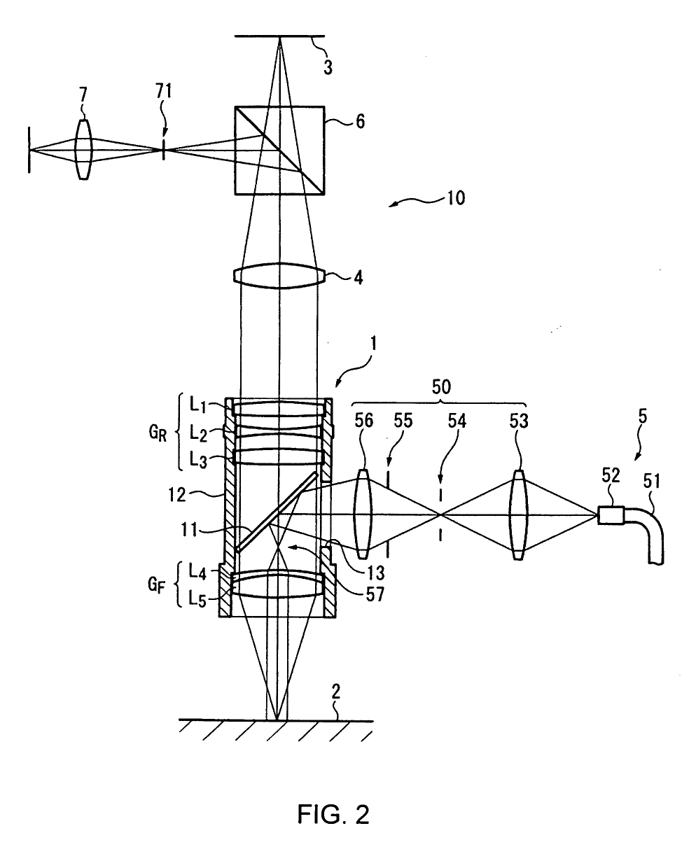

FIG. 2 is a diagram showing a microscope being an optical equipment in which the objective lens 1 is mounted. The microscope includes the optical system 10 shown in FIG. 1. As shown in FIG. 2, the microscope has the objective lens 1, the imaging lens 4, the illumination device 5, a semitransparent mirror 6 for an ocular lens, and the ocular lens 7. The microscope includes an illumination optical system 50 which is configured on the optical path of the illumination beam from the illumination device 5. In addition, in this microscope, the light reflected by the object plane 2 and entered into the objective lens 1 is imaged on the image plane 3 through the imaging lens 4, and an image may be picked up by a CCD camera or a like image pickup device forming the image plane 3. Thus, the image of the object plane 2 can be acquired as an electronic picture. Light reflected by the semitransparent mirror 6 for the ocular lens and proceeding in the direction of the ocular lens 7 is guided to the ocular lens 7 through a mid-image position 71 and is imaged at a visual field position. Thus, a user is capable of ocularly observing the image of the object plane 2 at predetermined magnifications from the ocular lens 7.

The illumination device 5 includes a light source (not shown), which generates the illumination light, and an optical fiber 51. The optical fiber 51 causes the illumination light from the light source to exit from its exit side end part 52 toward the illumination optical system 50. The illumination optical system 50 is configured of (includes) a condensing lens 53, an aperture stop 54 for adjusting the light quantity of the illumination light, a field stop 55 for adjusting the visual field of the object plane, and a relay lens 56 as are arranged in order from the side of the exit side end part 52. The illumination optical system 50 is for entering the illumination light from the optical fiber 51 into the semitransparent mirror 11 of the objective lens 1.

The front-group lens G_{F} of the objective lens 1 turns the illumination light reflected by the semitransparent mirror 11 into a parallel beam, which is projected onto the object plane 2. In this manner, Koehler illumination is formed by the illumination optical system 50. That is, the illumination light entered into the semitransparent mirror 11 is imaged onto the focal position 57 of the front-group lens G_{F} on the side of the transparent mirror 11, thereby being uniformly projected onto the whole visual field range of the object plane 2 without being directly imaged onto the object plane 2.

The objective lens 1 includes a holding cylinder 12, which is a cylinder member of substantially circular cylindrical shape. The front-group lens G_{F} and rear-group lens G_{R} in one pair are assembled and held within the holding cylinder 12. In the holding cylinder 12, a hole 13 penetrates into the interior of the holding cylinder 12. The hole 13 is formed in the substantially central part of an outer wall surface of the holding cylinder 12. The semitransparent mirror 11 onto which the illumination light is projected through the hole 13 is assembled and held. As stated before, the semitransparent mirror 11 is arranged between the front-group lens G_{F} and the rear-group lens G_{R}.

The front-group lens G_{F} is made of a cemented lens in which a lens L5 and a lens L4 are stuck together in order nearer from the side of the object plane 2. The semitransparent mirror 11 reflects the illumination light entered from the illumination device 5 toward the front-group lens G_{F}. The semitransparent mirror 11 transmits light reflected by the object plane 2 and turned into a parallel beam by the front-group lens G_{F} therethrough and guides the parallel beam to the rear-group lens G_{R}. The rear-group lens G_{R} is made of a lens L3, a lens L2 and a lens L1, which are separated from one another, in order nearer from the side of the object plane 2, and is formed of a triplet in which one concave lens is arranged between two convex lenses at spaced intervals. Owing to such a rear-group lens G_{R}, the various aberrations of light to be imaged onto the image plane 3 are corrected.

The light corrected by the rear-group lens G_{R} is guided to the imaging lens 4 in the state of a parallel beam. That is, the microscope is designed as an infinity correction optical system, which creates the image of the object plane 2 by using the objective lens 1 and the imaging lens 4.

Any of the following advantages labeled (1)-(7) may be achieved.

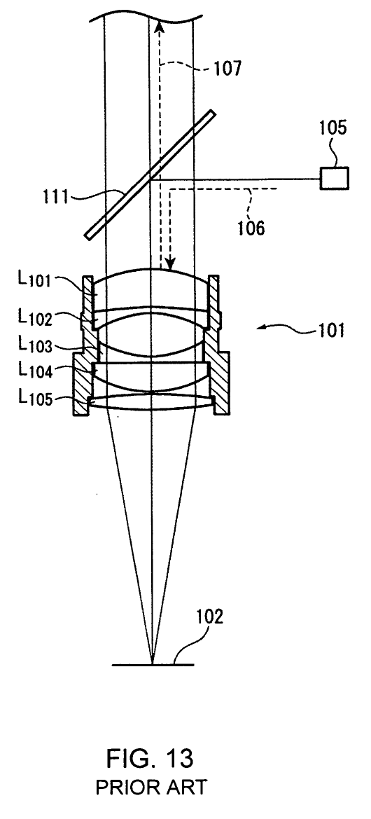

(1) In comparison with the prior-art objective lens 101, six surfaces in the prior-art objective lens 101, as shown in FIG. 13, generate flare light, whereas according to the objective lens 1, only the two surfaces of the lenses L4 and L5 generate flare light. Thus, flare light quantity can be reduced to ⅓.

(2) Since the lenses L1, L2 and L3 constituting the rear-group lens G_{R} do not affect the generation of flare light, design versatility is increased. That is, the rear-group lens G_{R} is a triplet of the lenses L1, L2 and L3, whereby the various aberrations can be corrected and lens performance can be enhanced.

(3) The light between the front-group lens G_{F} and the rear-group lens G_{R} is turned into a parallel beam, whereby the arrangement of the optical system can be provided with versatility, which can allow the semitransparent mirror 11 to be inserted.

(4) Multilayer antireflection films have heretofore been sometimes formed on the lens surfaces in order to reduce flare light. In the case of observing a workpiece of low reflectivity, flare light, which cannot be prevented by the multilayer antireflection films, is sometimes generated and poses a problem in practical use. In contrast, flare light can be reduced without employing the multilayer antireflection films in embodiments described herein, and hence, even the workpiece of low reflectivity can be observed.

(5) The radii of curvatures of the lens surfaces, for example, have heretofore been sometimes altered in order to reduce flare light. But in order to reduce flare light, the radii of curvatures often need to be altered in a manner that worsens the aberrations and imposes limitation on optical design. Also, lens shapes which are difficult to manufacture are liable to be a problem. In contrast, flare light can be reduced without altering the shapes of the lenses in embodiments disclosed herein, so that the lenses can be easily manufactured without imposing limitations on the optical design thereof.

(6) A λ/4 wavelength plate has heretofore been sometimes attached in order to reduce flare light, but a loss of light quantity is involved due to a polarizing optical element which is used simultaneously with the λ/4 wavelength plate. This has been a problem that leads to increased manufacturing cost. In contrast, flare light can be reduced without attaching the λ/4 wavelength plate, and hence, light quantity loss and increased manufacturing cost can be avoided in embodiments disclosed herein.

(7) In the case where only the number of lenses constituting the rear-group lens G_{R} is increased without altering the lens configuration of the front-group lens G_{F}, the reduction in flare light generated can be maintained because the lens configuration of the front-group lens G_{F} is the same. Owing to the increased number of lenses constituting the rear-group lens G_{R}, correction of the various aberrations by the rear-group lens G_{R} becomes more favorable and lens performance can be sharply enhanced.

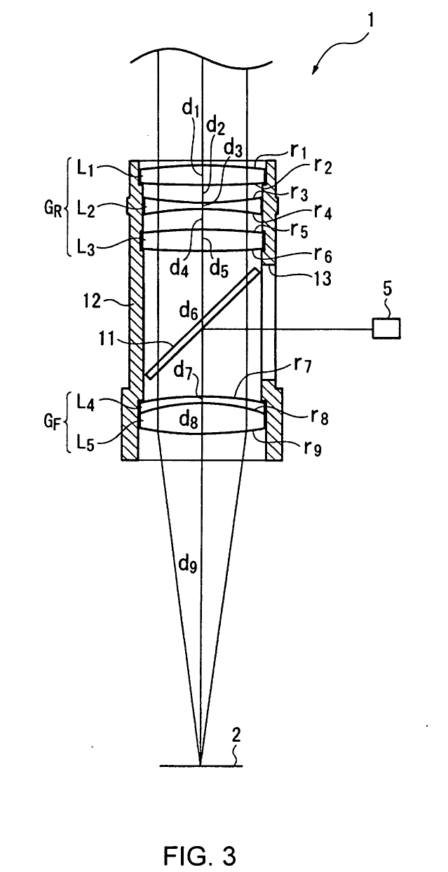

Now, particular examples will be described in conjunction with the drawings. FIG. 3 is a diagram showing the configuration of the objective lens 1 of a first embodiment. In the objective lens 1, the optical constants of individual lenses are set, as indicated in Table 1, under the conditions (specifications 1) of a focal distance f: 100 mm, an N. A. (Numerical Aperture): 0.15, and a visual field: φ1 mm. Here, r₁-r₉ denote the radii of curvatures of the respective surfaces of the individual lenses, d₁-d₉ denote the thicknesses of the lenses, Nd₁-Nd₅ denote the refractive indices of glass materials at the wavelength of d-rays (587.56 nm), and νd₁-νd₅ denote the Abbe numbers of the glass materials. Incidentally, the focal distance f in the conditions indicates values at the d-rays.

TABLE 1

| | Radius of | | Thickness | | Refractive Index | | Dispersion | |
|---|---|---|---|---|---|---|---|---|
| Surface No. | Curvature (r) | | (d) | | (Nd) | | (νd) | |
| 1 | r₁ | 125.7 | d₁ | 5.0 | Nd₁ | 1.62 | νd₁ | 60.3 |
| 2 | r₂ | −200.8 | d₂ | 5.0 | | | | |
| 3 | r₃ | −79.8 | d₃ | 1.5 | Nd₂ | 1.52 | νd₂ | 56.4 |
| 4 | r₄ | 75.7 | d₄ | 5.0 | | | | |
| 5 | r₅ | 211.6 | d₅ | 5.0 | Nd₃ | 1.62 | νd₃ | 60.3 |
| 6 | r₆ | −277.1 | d₆ | 30.0 | | | | |
| 7 | r₇ | 75.7 | d₇ | 1.5 | Nd₄ | 1.75 | νd₄ | 32.4 |
| 8 | r₈ | 46.1 | d₈ | 8.0 | Nd₅ | 1.50 | νd₅ | 81.6 |
| 9 | r₉ | −86.9 | d₉ | 92.5 | | | | |

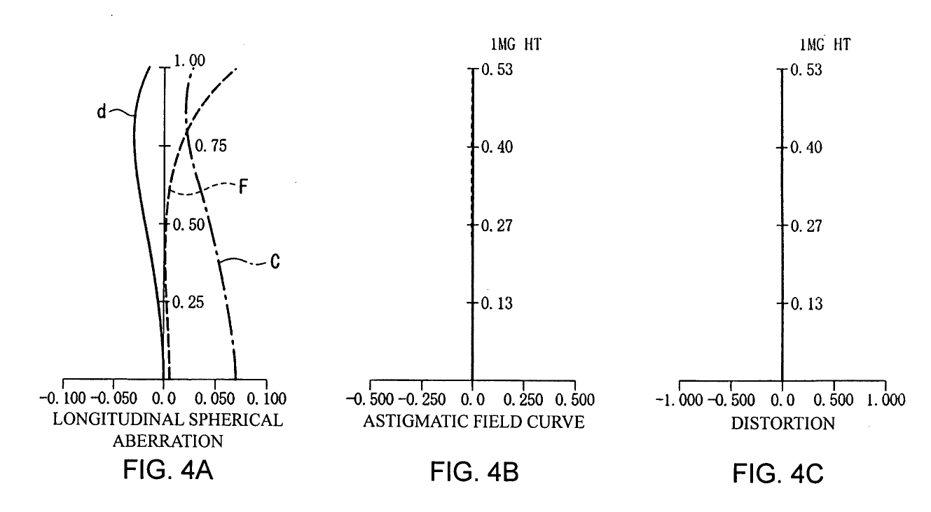

Optical paths in this embodiment are shown in FIG. 3. Longitudinal spherical aberrations, astigmatic field curves and distortions in this embodiment are shown in FIG. 4. In FIG. 4, d, F and C indicate the wavelengths of d-rays, F-rays and C-rays, respectively. As shown in FIG. 4, and according to the objective lens 1 of this embodiment, the various aberrations are favorably corrected.

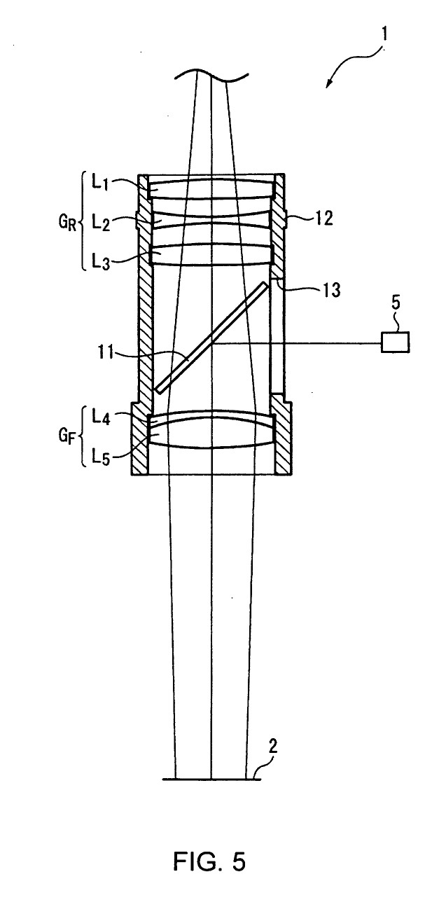

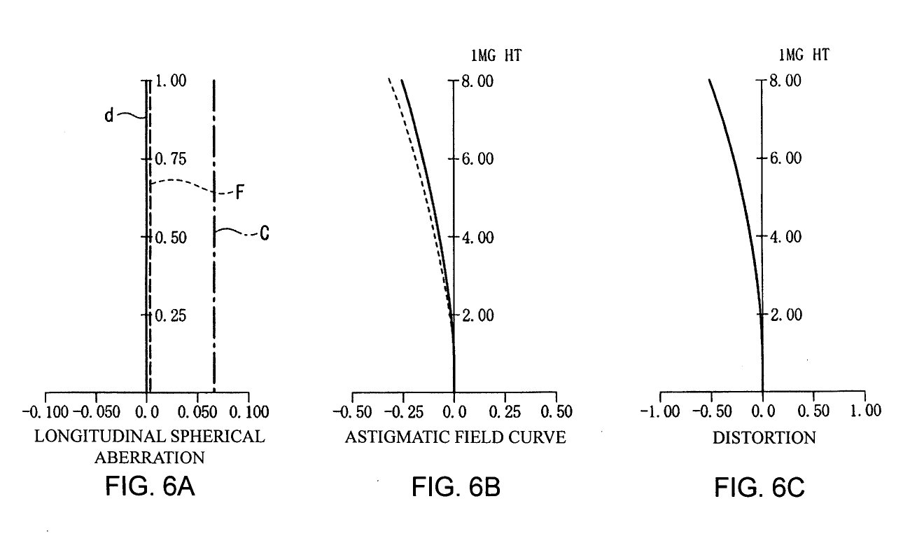

FIG. 5 is a diagram showing the configuration of the objective lens 1 of a second embodiment. FIG. 6 is a diagram showing longitudinal spherical aberrations, astigmatic field curves and distortions in this embodiment. As shown in FIG. 5, the configuration of the individual lenses of the objective lens 1 of the first embodiment is employed and the conditions (specifications 1) stated before are changed into the conditions (specifications 2) of a focal distance f: 100 mm, an N. A.: 0.01, and a visual field: φ16 mm. In the specifications 2, the N. A. is set to be smaller than in the specifications 1, so that resolution decreases, but an image of larger focal depth can be obtained. As shown in FIG. 6, it is seen that the various aberrations are favorably corrected also under these conditions (specifications 2).

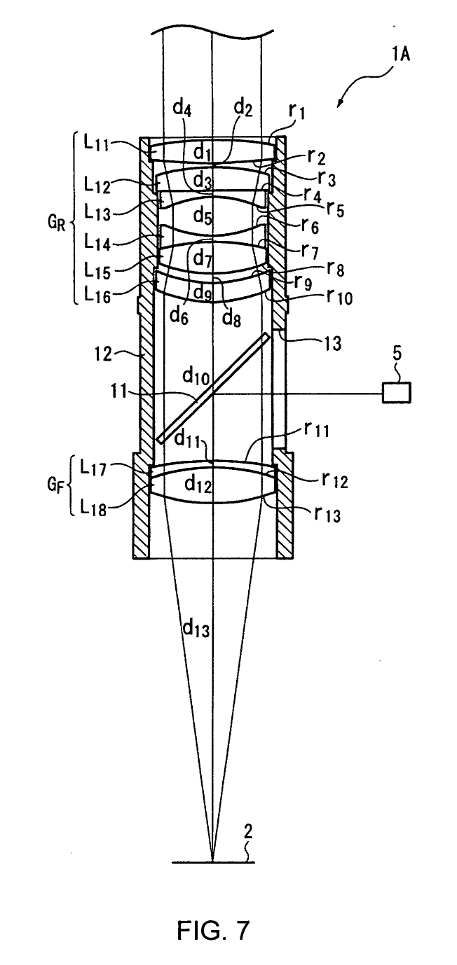

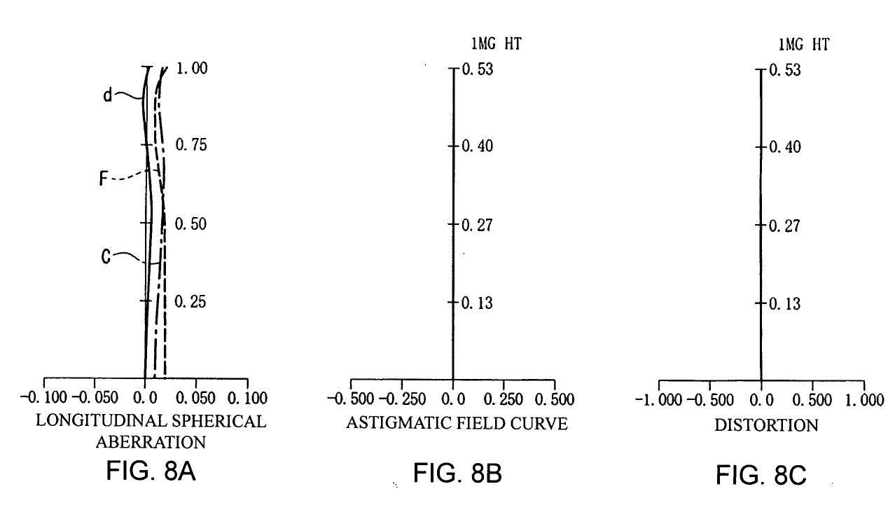

FIG. 7 is a diagram showing the configuration of the objective lens 1A of a third embodiment. FIG. 8 is a diagram showing longitudinal spherical aberrations, astigmatic field curves and distortions in this embodiment. The objective lens 1A differs from the foregoing objective lens 1 of the first embodiment in the configuration of the rear-group lens G_{R} and is substantially similar in the remaining configuration. That is, the objective lens 1A has a configuration in which the front-group lens G_{F}, the semitransparent mirror 11 and the rear-group lens G_{R} are similarly arranged.

The front-group lens G_{F} is made of a cemented lens in which a lens L₁₈ and a lens L₁₇ are stuck together in order nearer from the side of the object plane 2. The rear-group lens G_{R} consists of a cemented lens in which a lens L₁₆, a lens L₁₅ and a lens L₁₄ are stuck together in order nearer from the side of the object plane 2, a cemented lens in which a lens L₁₃ and a lens L₁₂ are stuck together, and a lens L₁₁. In this embodiment, three more lenses are included in the rear-group lens G_{R} than shown in the objective lens 1 of the first embodiment. The various aberrations are corrected by such a rear-group lens G_{R}.

In such a configuration, the optical constants of individual lenses are set as indicated in Table 2 under the conditions (specifications 3) of a focal distance f: 100 mm, an N. A.: 0.15, and a visual field: φ1 mm. Here, r₁-r₁₃ denote the radii of curvatures of the respective surfaces of the individual lenses, d₁-d₁₃ denote the thicknesses of the lenses, Nd₁-Nd₈ denote the refractive indices of glass materials at the wavelength of d-rays, and νd₁-νd₈ denote the Abbe numbers of the glass materials. Incidentally, the focal distance f in the conditions indicates values at the d-rays.

TABLE 2

| | Radius of | | Thickness | | Refractive | | Dispersion | |
|---|---|---|---|---|---|---|---|---|
| Surface No. | Curvature (r) | | (d) | | index (Nd) | | (νd) | |
| 1 | r₁ | 73.1 | d₁ | 6.0 | Nd₁ | 1.50 | νd₁ | 81.6 |
| 2 | r₂ | −117.3 | d₂ | 1.0 | | | | |
| 3 | r₃ | 47.7 | d₃ | 6.0 | Nd₂ | 1.76 | νd₂ | 27.5 |
| 4 | r₄ | Infinite | d₄ | 1.5 | Nd₃ | 1.75 | νd₃ | 35.3 |
| 5 | r₅ | 28.8 | d₅ | 10.0 | | | | |
| 6 | r₆ | −26.3 | d₆ | 1.5 | Nd₄ | 1.55 | νd₄ | 59.8 |
| 7 | r₇ | 50.2 | d₇ | 8.0 | Nd₅ | 1.50 | νd₅ | 81.6 |
| 8 | r₈ | −37.5 | d₈ | 2.5 | | | | |
| 9 | r₉ | −32.2 | d₉ | 5.0 | Nd₆ | 1.50 | νd₆ | 81.6 |
| 10 | r₁₀ | −32.2 | d₁₀ | 40.0 | | | | |
| 11 | r₁₁ | 113.1 | d₁₁ | 1.5 | Nd₇ | 1.67 | νd₇ | 48.3 |
| 12 | r₁₂ | 37.5 | d₁₂ | 10.0 | Nd₈ | 1.50 | νd₈ | 81.6 |
| 13 | r₁₃ | −52.9 | d₁₃ | 92.5 | | | | |

Optical paths in this embodiment are shown in FIG. 7. As shown in FIG. 8, the various aberrations are more favorably corrected in this embodiment than in the first embodiment as shown by the results of the longitudinal spherical aberrations, astigmatic field curves and distortions. More specifically, when the objective lens 1A of this embodiment is compared with the objective lens 1 of the first embodiment, the lens configuration of the front-group lens G_{F} is identical so the reduction in flare light generated can be maintained. The number of lenses constituting the rear-group lens G_{R} is enlarged by three so that various aberrations are favorably corrected by the rear-group lens G_{R} and lens performance can be sharply enhanced.

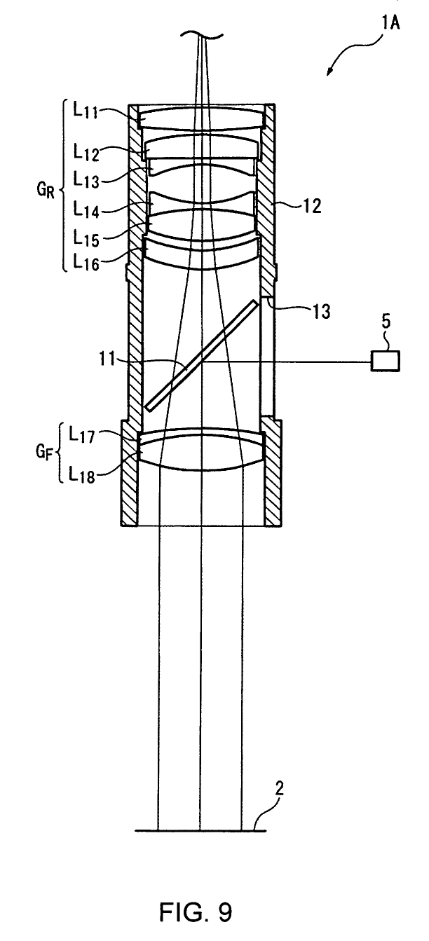

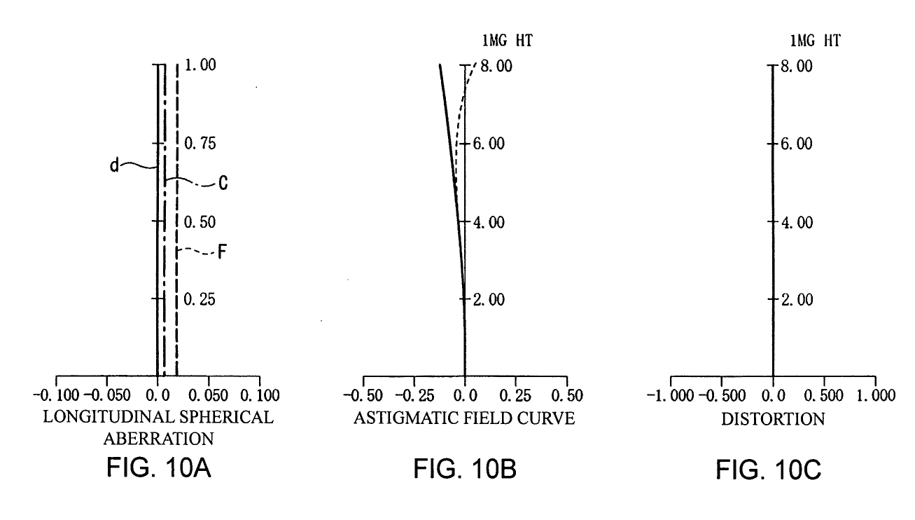

FIG. 9 is a diagram showing the configuration of the objective lens 1A of the fourth embodiment. FIG. 10 is a diagram showing longitudinal spherical aberrations, astigmatic field curves and distortions in this embodiment. As shown in FIG. 9, the configuration of the individual lenses of the objective lens 1A of the third embodiment is employed and the conditions (specifications 3) stated before are changed into the conditions (specifications 4) of a focal distance f: 100 mm, an N. A.: 0.01, and a visual field: φ16 mm. In the specifications 4, the N. A. is set to be smaller than in the specifications 1, so that resolution decreases, but an image of larger focal depth can be obtained. As shown in FIG. 10, it is seen that the various aberrations are more favorably corrected under the conditions (specification 4) than in the first embodiment.

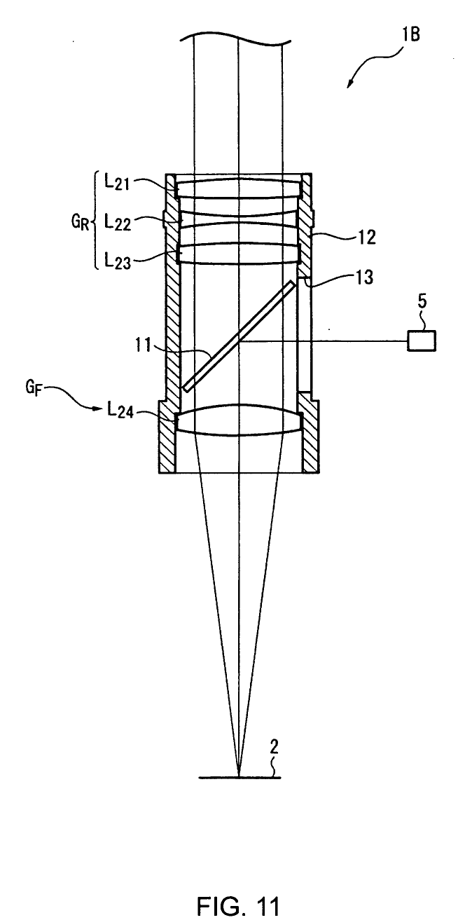

Embodiments are not restricted to the foregoing disclosure, but include any ordinary modifications, improvements, etc. By way of example, the embodiments have been described by exemplifying the case where the front-group lens G_{F} is made of the cemented lens in which the two lenses are stuck together, but the front-group lens G_{F} of an objective lens 1B may well be made of a single aspherical lens L₂₄ as shown in FIG. 11. Incidentally, the rear-group lens G_{R} is configured of three lenses L₂₁, L₂₂ and L₂₃ in the same manner as in embodiments described above. According to such an objective lens 1B, only one aspherical lens L₂₄ generates flare light so the quantity of flare light can be reduced still further.

In each of the embodiments, the objective lens is described in combination with the imaging lens 4, but an objective lens may well have the function of imaging light onto the image plane without being combined with an imaging lens.

In each of the embodiments, the imaging lens 4 may well be a zoom imaging lens, which has zoom function. An objective lens for combination with a zoom imaging lens sometimes has a greater number of constituent lenses in order to optimize aberrations at a tele-end (the position of the zoom imaging lens affording the largest magnifications, namely, the position of the maximum N. A.) and a wide-end (the position of the zoom imaging lens affording the smallest magnifications). Consequently, flare light sometimes becomes more problematic. Accordingly, flare light can be more effectively reduced by combining an objective lens of embodiments described herein with the zoom imaging lens.

Although each of the embodiments has described the case where the light between the front-group lens G_{F} and the rear-group lens G_{R} becomes a parallel beam, the light is not restricted to parallel beam form, but may well be condensed light or divergent light. By way of example, embodiments also cover the case where illumination light is adjusted and entered so that the light between the front-group lens G_{F} and the rear-group lens G_{R} may not completely become a parallel beam, but may be somewhat condensed or be somewhat divergent. In this manner, the light between the front-group lens G_{F} and the rear-group lens G_{R} is not strictly a parallel beam, thereby saving apparatus space.

Embodiments describe an illumination optical system 50 for providing Koehler illumination, but the illumination optical system 50 may well provide any illumination other than the Koehler illumination.

Embodiments are applicable to objective lenses which are mounted in a microscope or like optical equipment, as well as those mounted in a projector, a picture processing measurement equipment or the like.

While various details have been described, these details should be viewed as illustrative, and not limiting. Various modifications, substitutes, improvements or the like may be implemented within the spirit and scope of the foregoing disclosure.

What is claimed is:

1. An objective lens, comprising:
a front-group lens;
a rear-group lens arranged on an optic axis of the front-group lens with the front-group lens interposed between an object plane and the rear-group lens; and
a semitransparent mirror arranged between the front-group lens and the rear-group lens, the semitransparent mirror being capable of reflecting illumination light into the front-group lens, transmitting reflected light from the object plane and entering the transmitted light into the rear-group lens;
wherein the front-group lens comprises a single lens or a cemented lens formed by sticking two lenses together.

2. An objective lens as defined in claim 1, wherein the rear-group lens comprises a plurality of lenses.

3. An objective lens as defined in claim 1, wherein light passes between the front-group lens and the rear-group lens parallel to the optic axis.

4. An objective lens as defined in claim 1, further comprising:
a holding cylinder being comprised of a cylinder member of substantially circular cylindrical shape in which the front-group lens, the semitransparent mirror and the rear-group lens are assembled and held; and
a hole in a substantially central part of an outer wall surface of the holding cylinder;
wherein light illuminates the object plane by entering into the semitransparent mirror through the hole.

5. An objective lens as defined in claim 2, wherein the plurality of lenses comprises a first lens, a second lens and a third lens.

6. An objective lens as defined in claim 5, wherein the first lens is convex, the second lens is concave and the third lens is convex, and the second lens is provided between the first lens and the third lens at spaced intervals.

7. An objective lens as defined in claim 2, wherein the plurality of lenses comprises a first lens, a second lens, a third lens, a fourth lens, a fifth lens and a sixth lens, whereby the first, second and third lenses form a first cemented lens, the fourth and fifth lenses form a second cemented lens, and the first cemented lens, the second cemented lens and the sixth lens are provided at spaced intervals.

8. An objective lens as defined in claim 7, wherein the second cemented lens is provided between the sixth lens and the first cemented lens.

9. A microscope, comprising:
an illumination device being capable of providing illumination light from a light source;
an optical system comprising an imaging lens and an objective lens on an optical axis, the objective lens being comprised of a semitransparent mirror provided between a rear-group lens and a front group lens on the optical axis; and
an illumination system on an optical path of the illumination device, the illumination system being capable of entering light into the optical system.

10. The microscope of claim 9, wherein the front-group lens comprises a single lens or a cemented lens.

11. The microscope of claim 9, wherein the rear-group lens comprises a plurality of lenses.

12. The microscope of claim 11, wherein the plurality of lenses comprises a first lens, a second lens and a third lens.

13. The microscope of claim 12, wherein the first lens is convex, the second lens is concave and the third lens is convex, and the second lens is provided between the first lens and the third lens at spaced intervals on the optical axis.

14. The microscope of claim 11, wherein the plurality of lenses comprises a first lens, a second lens, a third lens, a fourth lens, a fifth lens and a sixth lens, whereby the first, second and third lenses form a first cemented lens, the fourth and fifth lenses form a second cemented lens, and the first cemented lens, the second cemented lens and the sixth lens are provided at spaced intervals on the optical axis.

15. The microscope of claim 14, wherein the second cemented lens is provided between the sixth lens and the first cemented lens on the optical axis.

16. A method of reducing flare light by an objective lens, comprising:
providing a rear-group lens on an optical axis between an image plane and an object plane;
providing a front-group lens on the optical axis closer to the object plane than the rear-group lens; and
providing a semitransparent mirror between the rear-group lens and the front-group lens on the optical axis, wherein the semitransparent mirror is configured to receive light from a light source.

17. The method of claim 16, wherein the front-group lens comprises a single lens or a cemented lens.

18. The method of claim 16, wherein the rear-group lens comprises a plurality of lenses.
